(19) United States
(12) Patent Application Publication
(10) Pub. No.: US 2008/0216143 A1
(43) Pub. Date: Sep. 4, 2008

(54) METHOD FOR RECEIVING IP BROADCAST AND A RECEIVING TERMINAL

(76) Inventors: Hiroki Ikeda, Hachioji (JP); Kenichi Sakamoto, Kokubunji (JP); Hideki Kamimaki, Fujisawa (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/947,229

(22) Filed: Nov. 29, 2007

(30) Foreign Application Priority Data
Dec. 20, 2006 (JP) 2006-343306

(51) Int. Cl. H04N 7/00

(52) U.S. Cl. 725/116

(57) ABSTRACT

An IP broadcast terminal 30 is connected with a multicast address management device 10 for IP broadcast that holds multicast information via an IP multicast network 40 over which IP broadcast service is provided, and when a user issues a request to change an IP broadcast channel, generates a query message including an IP broadcast channel identifier requested from the IP broadcast terminal 30 to transmits it to the multicast address management device 10 for IP broadcast. The IP broadcast terminal 30 receives a response message showing the correspondence between IP broadcast channel identifiers and multicast addresses from the multicast address management device 10 for IP broadcast, and transmits a video reception request message to a multicast group decided for reception.

### CLAIM OF PRIORITY

The present application claims priority from Japanese application JP 2006-343306 filed on Dec. 20, 2006, the content of which is hereby incorporated by reference into this application.

### BACKGROUND OF THE INVENTION

This invention, which relates to Internet protocol (IP) broadcast service, relates to IP broadcast reception technology in broadcast/communication merging service that uses multicast communication.

Multicast communication, which is technology for transmitting IP datagrams to members belonging to a multicast group while being copied by multicast routers, is already developed in a wide range. So-called multicast technology, which complies with standard documents RFCs (Request for Comments) 1112, 2236, and 3376 publicized in IAB (Internet Architecture Board), prepared by IETF (Internet Engineering Task Force), is technology for the management and notification of information about members in a group to perform the multicast communication. This technology, also called IGMP (Internet Group Management Protocol) in the above-described RFCs, is applied to multicast routers. Multicast communication is executed by multicast routers to which these technologies are applied. MLD (Multicast Listener Discovery) complying with RFCs 2710 and 3810 is used. This is applied to multicast communication meeting IPv6.

The feature of multicast communication is to have only to transmit one multicast IP datagram during transmission. Specifically, multicast IP datagrams are automatically copied by multicast routers to which IGMP is applied, and transmitted to a network to which members of a multicast group belong. A multicast IP datagram is identified by one address value called a multicast address.

Recently, in IPTV (Internet Protocol TV) broadcast service, the multicast technology is applied. In broadcast service, a multicast address is allocated to a broadcast channel of IPTV for distribution to a multicast group by a network comprising multicast routers. On the other hand, IP broadcast terminals being viewers of IPTV broadcast channel participate in the multicast group when wanting to receive IPTV broadcasts, and can receive the IPTV broadcasts by becoming members of the multicast group. In this case, the IP broadcast terminals must previously know IP information such as multicast address information. The management and notification of such information concerning members of multicast are executed by IGMP and MLD.

However, in actual IPTV broadcast service, IP broadcast users select an IPTV broadcast channel to view from an IPTV broadcast channel name and a channel number offered by the broadcaster. Accordingly, the IP broadcast terminals must locate a multicast address from the channel number acquire IP broadcast data from a network. However, when the IP broadcast terminals increase as the number of IP broadcast programs provided, the number of IP broadcast channels, and the number of users increase, it is extremely difficult that the IP broadcast terminals manage and acquire all multicast addresses on the network.

For example, as shown in FIG. 16, IP broadcast servers 41 convert an IPTV broadcast channel into IP datagrams and distributes them to IP broadcast terminals 42 by a multicast network. In this case, the IP broadcast terminals, to receive the IPTV broadcast channel, must become members of a multicast group of the channel, and further make queries to the plural IP broadcast servers 41 to know a multicast address. However, when plural IP broadcast server exists, the load of querying increases. Since the status of the IP broadcast terminals changes with time, it is apparent that the IP broadcast terminals increase in the load of acquiring TV broadcast channel information and multicast address information in real time.

On the other hand, Japanese Unexamined Patent Publication No. 2006-174453 discloses a method of generating correction EPG information including IP information classified by broadcast channels in EPG (Electronic Program Guide) information including information about program contents and program kinds during broadcast digital service, and multiplexing the information in broadcast streams for transmission to users' terminals.

### BRIEF SUMMARY OF THE INVENTION

Since conventional IP broadcast servers do not have a function to convey information on TV broadcast channels and information on multicast addresses to users, for new addition of IP broadcast terminals, multicast information cannot be efficiently conveyed. When EPG information is used, since EPG is added to broadcast streams, EPG information of a relevant program can be received only when the broadcast streams are being received. Therefore, mere addition of a new broadcast program by a broadcaster has been useless as means for conveying the EPG information and IP information included in it to users.

An object of this invention is to provide an IP broadcast receiving method for eliminating a need for a broadcaster to set IP broadcast channel information and multicast addresses, and for reducing the load of conveying multicast addresses to IP broadcast terminals, and the IP broadcast terminals.

To achieve the above-described object, this invention provides an IP broadcast receiving method for receiving IP broadcast service in an IP broadcast terminal via an IP multicast network. An IP broadcast server that can distribute videos indicating a multicast address, and a multicast address management device for IP broadcast that holds multicast addresses are connected to the IP multicast network. The IP broadcast terminal generates a query message including an IP broadcast channel identifier requested from a user, transmits the generated query message to the multicast address management device for IP broadcast, receives a response message including a multicast address corresponding to the IP broadcast channel identifier included in the query message from the multicast address management device for IP broadcast, and transmits a video reception request message to a multicast group decided for reception, using the multicast address included in the received response message.

That is, in this invention, the IP broadcast server that can distribute videos indicating a multicast address, and the multicast address management device for IP broadcast that holds IP broadcast channel identifiers and corresponding multicast addresses are connected to the IP multicast network.

The IP broadcast terminal generates a query message including an IP broadcast channel identifier requested from a user, and transmits the generated query message to the multicast address management device for IP broadcast.

It receives a response message including a multicast address corresponding to an IP broadcast channel identifier included in the query message from the multicast address management device for IP broadcast. It uses the multicast address included in the received response message to transmit a video reception request message to a multicast group that has decided reception, and receives a desired video.

According to this invention, in IP broadcast service via an IP network, in conjunction with the multicast address management device for IP broadcast, the IP broadcast terminal can efficiently manage IP broadcast channel numbers and multicast addresses.

Even if the number of IPTV broadcast channels increases, in conjunction with the multicast address management device for IP broadcast, only multicast addresses for necessary IP broadcast channel numbers can be obtained. Therefore, a load caused by a change in the number of IPTV broadcast channels is reduced, and the load of the IP broadcast terminal can be reduced.

Furthermore, even if the number of IP broadcast terminals increases, in conjunction with the multicast address management device for IP broadcast, a multicast address can be obtained without accessing all IP broadcast servers. Therefore, a load caused by a change in the number of IP broadcast terminals is reduced, and the load of the IP broadcast terminal can be reduced.

Still furthermore, since the multicast address management device for IP broadcast collectively manage IP broadcast channel identifiers and multicast addresses, in an IP broadcast system, an increase/decrease in the number of users, and an increase/decrease load of the number of channels of IP broadcast can be reduced. By conjunction between the IP broadcast terminal and the multicast address management device for IP broadcast, the load on a broadcaster to set a multicast address in an IP broadcast terminal is reduced.

### BRIEF DESCRIPTION OF THE DRAWINGS

FIG. 1 is a drawing for explaining an IP broadcast system to which an IP broadcast management method of a first embodiment of this invention is applied, a multicast address management device for IP broadcast, and IP broadcast terminals.

FIG. 2 is a flowchart of multicast address resolution operation executed by IP broadcast terminals of the first embodiment.

FIG. 3 is a flowchart of multicast address resolution operation executed by a multicast address management device for IP broadcast of the first embodiment.

FIG. 4 is a drawing showing a configuration of IP broadcast channel identifier-multicast address binding table of the first embodiment.

FIG. 5 is a drawing showing a configuration of an IP broadcast channel management table of the first embodiment.

FIGS. 6A-6B are drawings showing examples of message format of the first embodiment.

FIG. 7 is a flowchart of multicast address allocation operation executed by a multicast address management device for IP broadcast of the first embodiment.

FIG. 8 is a drawing showing a configuration of a multicast address pool table of the first embodiment.

FIG. 9 is a basic message sequence diagram of the first embodiment.

FIG. 10 is a flowchart of multicast address deallocation operation executed by a multicast address management device for IP broadcast of the first embodiment.

FIG. 11 is a message sequence diagram of multicast address deallocation of the first embodiment.

FIG. 12 is a drawing showing a configuration of a multicast address pool table of the first embodiment.

FIG. 13 is a drawing showing a configuration of a multicast address pool table of the first embodiment.

FIG. 14 is a flowchart of channel switching operation executed by IP broadcast terminals of the first embodiment.

FIG. 15 is a message sequence diagram of channel switching executed by IP broadcast terminals of the first embodiment.

FIG. 16 is a drawing for explaining a conventional IP broadcast system.

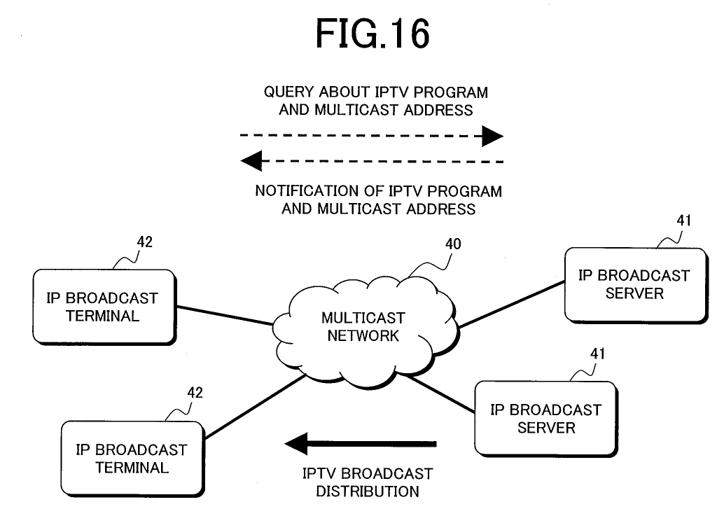

### DETAILED DESCRIPTION OF THE INVENTION

Hereinafter, embodiments of the present invention will be described with reference to the accompanying drawings. The case of using IPTV broadcast as an application is exemplified. However, it goes without saying that this invention is not limited to this application. The case of identifying a multicast group by using a multicast address is described. However, a combination of a multicast address and a source address may be used as a multicast group identifier. The multicast address, and combination of multicast address and source address that are used as a multicast group identifier are those stipulated in the above-described IGMP and MLD.

### First Embodiment

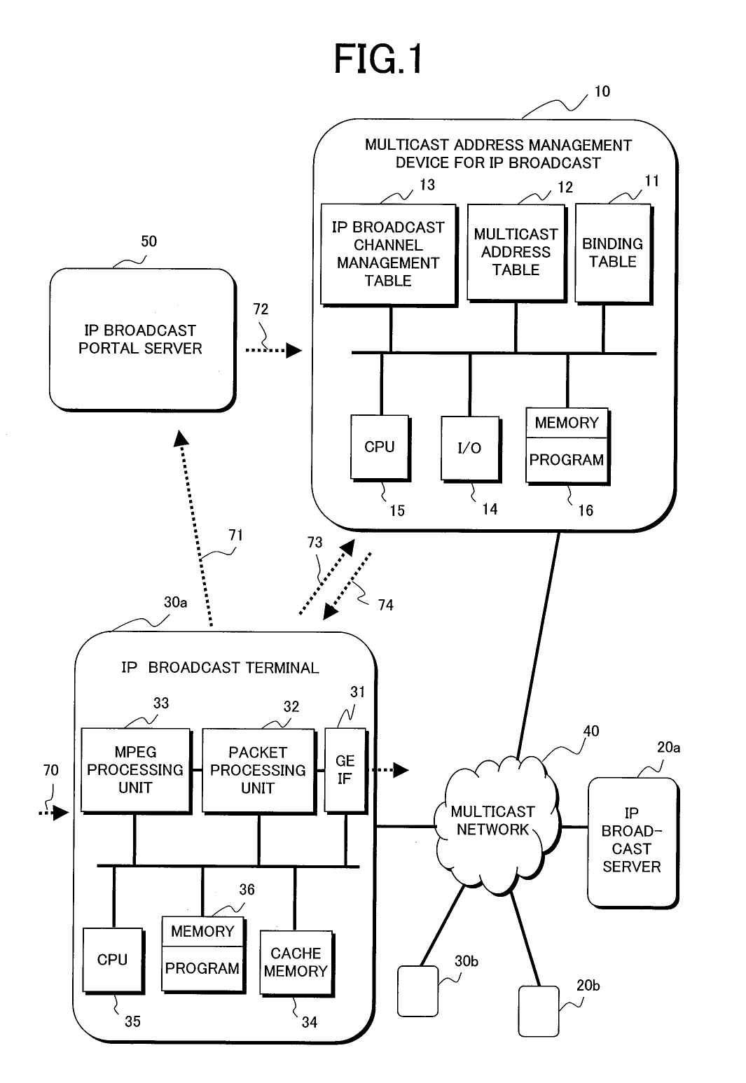

FIG. 1 is a drawing showing an IP broadcast terminal for receiving IP broadcast service and an IP broadcast communication system using its method according to a first embodiment.

First, a network configuration will be described. The IP broadcast service is performed between an IP broadcast server 20 and an IP broadcast terminal 30 via a multicast network 40. A multicast network 40 includes a multicast router capable of multicasting IP packets having a multicast address, and decides an IP broadcast terminal 30 of a destination, based on the multicast address. The number of IP broadcast terminals 30 may be plural. Although, in the drawing, the IP broadcast terminals 30 are connected directly to the multicast network 40, they may be connected to the network 40 via a set-top box having a media conversion function and the like.

A multicast address management device 10 for IP broadcast that functions as an IP broadcast channel management server of this embodiment is a server including: an IP broadcast channel identifier-multicast address binding table 11 that holds the correspondence of broadcast channel identifiers and multicast addresses; a multicast address pool table 12 for managing a list of multicast addresses that can be used on the network; and an IP broadcast channel management table 13 for managing a list of IP broadcast channel identifications that can be used on the network. The multicast address management device 10 for IP broadcast is connected to the IP broadcast server 20 and the IP broadcast terminals 30 via a network such as a multicast network 40.

In the IP broadcast channel identifier-multicast address binding table 11, as described later, IP broadcast channel identifiers set in the IP broadcast server and multicast addresses are set in advance. The multicast address pool table 12 initially contains multicast addresses usable in the network. The IP broadcast channel management table 13 previously contains IP broadcast channel identifiers capable of broadcasting in the network.

Multicast address management device 10 for IP broadcast further includes: an I/O interface 14 to transmit and receive messages from IP broadcast clients; a CPU (Central Processing Unit) 15 as a processing unit that processes the messages; and a memory 16 as a storage unit in which programs are stored.

The CPU 15 extracts a broadcast channel ID (identifier) from a message 73 received from the IP broadcast terminals 30 or a message 72 received from an IP broadcast portal server, and decides a multicast address corresponding to an IP broadcast channel identifier according to a program held in the memory 16 from the multicast address binding table 11. Then, the CPU 15 generates a message 74 including the decided multicast address, and outputs it to the I/O interface 14 for transmission to the IP broadcast terminals.

In the multicast address management device 10 for IP broadcast, the CPU 15 receives a request to allocate a multicast address to an IP broadcast channel identifier from the IP broadcast servers 20, decides a multicast address, based on the IP broadcast channel management table 13 and the multicast address pool table 12, and transmits it to the IP broadcast servers 20. The CPU 35 updates the IP broadcast channel identifier-IP broadcast channel identifier-multicast address binding table 11 according to the IP broadcast channel identifier and the decided multicast address.

The IP broadcast terminals 30 of this embodiment, which function as transmitting/receiving units, include: a GE interface 31 to receive IP packets; a packet processing unit 32 that selects and processes an IP packet to be received; an MPEG (Moving Picture Expert Group) processing unit 33 that processes video from the packet; a CPU 35 that controls them and processes messages; a memory 36 in which programs executed by the CPU 35 are stored; and a cache memory 34 whose functions will be described later. The cache memory 34 and the memory 36 constitute a storage unit of the IP broadcast terminals 30. It goes without saying that the packet processing unit 32 and the MPEG processing unit 33 may be configured not only by hardware but also by software. In this case, software processing of them is also executed by the CPU 35.

In the IP broadcast terminals 30, as a first method, the CPU 35 creates a message 73 including an IP broadcast channel identifier from a user's IP broadcast channel selection request 70 by input from an input unit such as a remote controller (not shown), and transmits it to the multicast address management device 10 for IP broadcast via the network. As a second method, the CPU 35 accesses an IP broadcast portal server 50 by using the HTTP (Hyper Text Transfer Protocol) or the like by input from an input unit such as keyboard (not shown) to create a message 72 including an IP broadcast channel identifier, and likewise can transmit it to the multicast address management device 10 for IP broadcast. Although the first method is used for description in embodiments that follow, it goes without saying that this invention is not limited to this method.

After that, the CPU 35 decides multicast address information from the message 74 received from the multicast address management device 10 for IP broadcast, and passes it to the packet processing unit 32. The packet processing unit 32 transmits a multicast group participation message according to the passed multicast address, and after reception has become possible, selects and processes an IP packet. For example, as participation messages, a Join message and the like of IGMPv2 of RFC (Request for Comments) 2236 can be used.

The CPU 35 of the IP broadcast terminals 30 updates the cache memory 34 according to the multicast address received from the multicast address management device 10 for IP broadcast and the IP broadcast channel identifier. From the next time, the CPU 35 searches the cache memory 34, thereby contributing to an increase in response speed of IP broadcast selection.

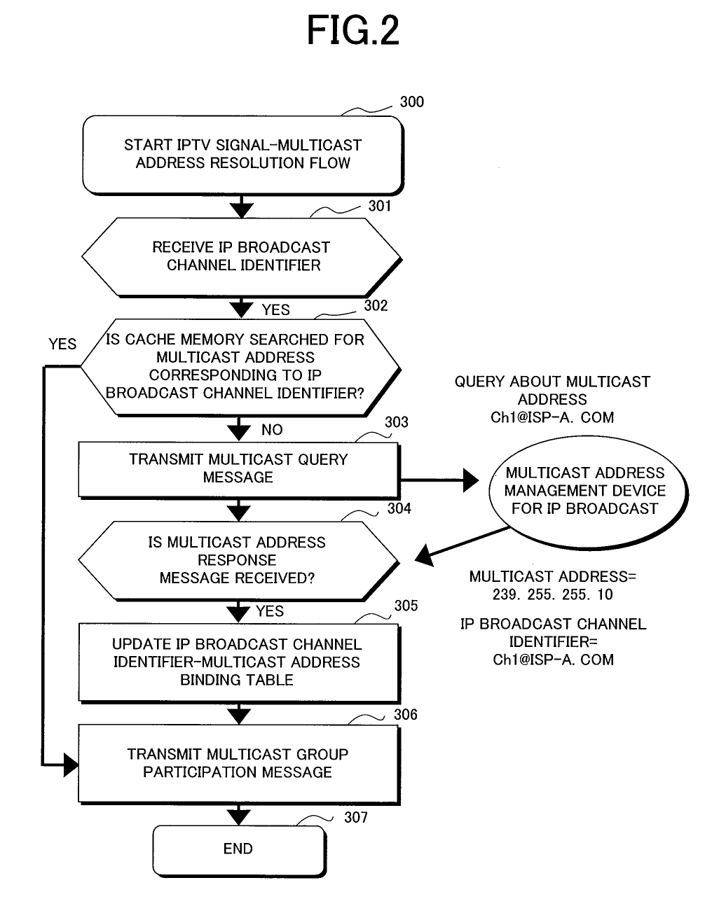

FIG. 2 shows a flowchart of multicast address resolution operation executed by the IP broadcast terminals 30 of this embodiment. Here, a description is made of the operation of the IP broadcast terminals 30 for receiving IP broadcast service of this embodiment. That is, the IP broadcast terminals 30 selectively receive IP packets of broadcast video from the multicast network 40, based on an IP broadcast channel identifier. A flow of the above operation is described. This flowchart is executed, for example, by the CPU 35 of the IP broadcast terminals 30.

First, the IP broadcast terminals 30 determine whether they receive an IP broadcast channel identifier including IP broadcast channel information viewed by a user as an IP broadcast channel selection request 70 (Step 301). Next, on receiving the IP broadcast channel identifier, they refers to the cache memory 34 to search for a multicast address (MCA: Multicast Address) corresponding to the IP broadcast channel identifier (Step 302).

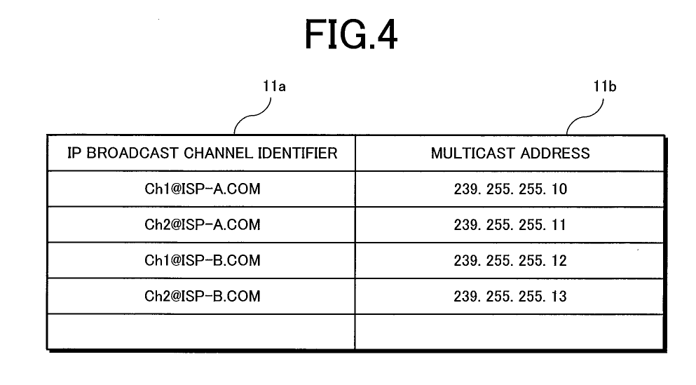

In the cache memory 34, for example, as shown in FIG. 4, the IP broadcast channel identifier-IP broadcast channel identifier-multicast address binding table 11 including a list of IP broadcast channel identifier 11a and multicast address 11b is stored. In this embodiment, for example, an IP broadcast channel identifier is “Ch1@ISP-A.COM,” and its multicast address is “239.255,255.10.1”

In Step 302, when a multicast address matching the IP broadcast channel identifier does not exist in the IP broadcast channel identifier-IP broadcast channel identifier-multicast address binding table 11 in the IP broadcast terminals 30, the IP broadcast terminals 30 transmit a multicast address query message including the IP broadcast channel identifier (Step 303).

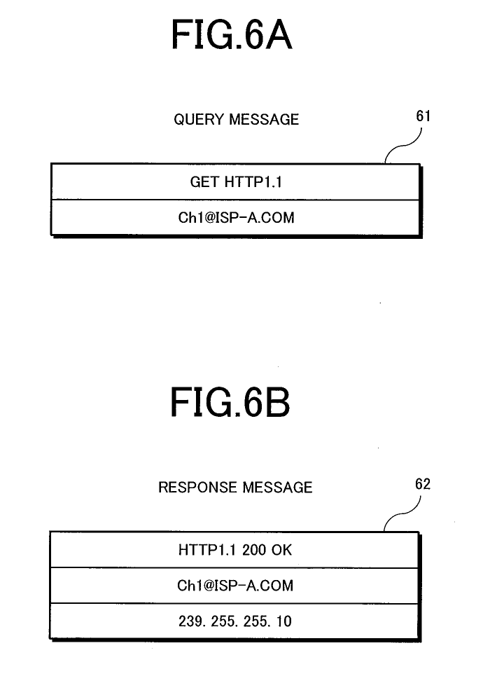

In this embodiment, a query message 61 includes an IP broadcast channel identifier, as shown in FIG. 6A, for example. As the format of the message, SIP URL (Session Initiation Protocol Uniform Resource Locator), XML (Extensible Markup Language), and the like may be used. An IP broadcast channel identifier has only to be information to identify an IP broadcast channel.

Next, the IP broadcast terminals 30 determine whether they have received a multicast address response message including the transmitted IP broadcast channel identifier and a corresponding multicast address (Step 304). When the multicast address response message has been received, the IP broadcast channel identifier and the multicast address are enrolled, and the IP broadcast channel identifier-multicast address binding table is updated (Step 305). In this embodiment, a response message 62 includes an IP broadcast channel identifier and a corresponding multicast address as shown in FIG. 6B, for example. As the format of the message, SIP URL, XML, and the like may be used. The multicast address may comply with IPv4 or IPv6.

Next, when having received a multicast address response message, or when a multicast address matching the IP broadcast channel identifier exists in the IP broadcast channel identifier-multicast address binding table 11 stored in the cache memory 34 in Step 302, the IP broadcast terminals 30 transmit a multicast group participation message to the multicast network 40 (Step 306). Thereby, an IP packet to transmit IPTV broadcast channel data indicated by the IP broadcast channel identifier can be received. The IP broadcast terminals 30 may not have the IP broadcast channel identifier-multicast address binding table 11. In this case, for example, in the flowchart of this embodiment, Steps 302 and 305 are unnecessary.

As the above results, the IP broadcast terminals 30 can reproduce an IP broadcast channel by receiving IP packets corresponding to the IP broadcast channel identifier.

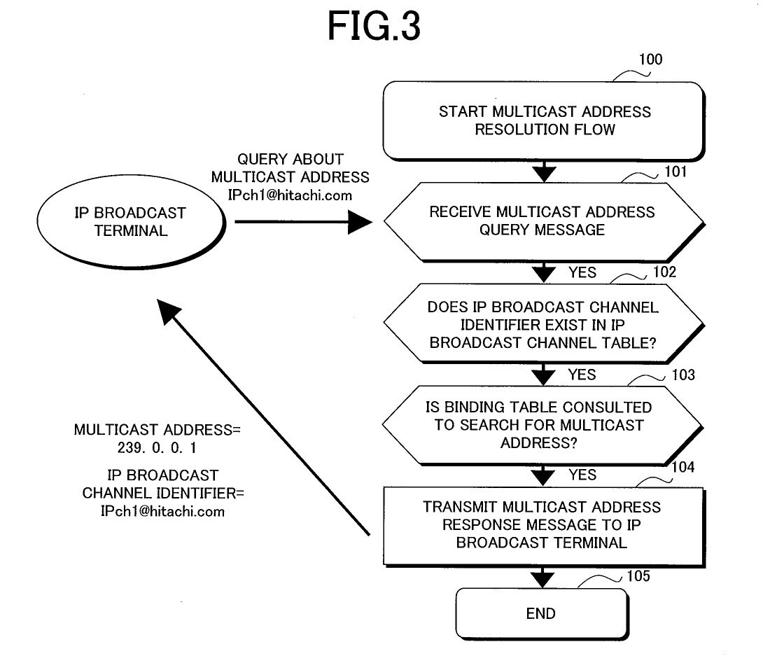

FIG. 3 shows an example of a flowchart of multicast address resolution operation executed by the multicast address management device 10 for IP broadcast in the first embodiment. That is, a description is made of an operation flow that the multicast address management device 10 for IP broadcast returns a multicast address in response to a query from the IP broadcast terminal 30a. In this embodiment, this flowchart is executed, for example, by the CPU 15 of the multicast address management device 10 for IP broadcast.

First, the multicast address management device 10 for IP broadcast determines whether it has received a multicast address query message including an IP broadcast channel identifier (Step 101). On receiving the multicast address query message, it extracts an IP broadcast channel identifier from the multicast address query message, and consults the IP broadcast channel management table 13 to decide whether the IP broadcast channel identifier exists (Step 102).

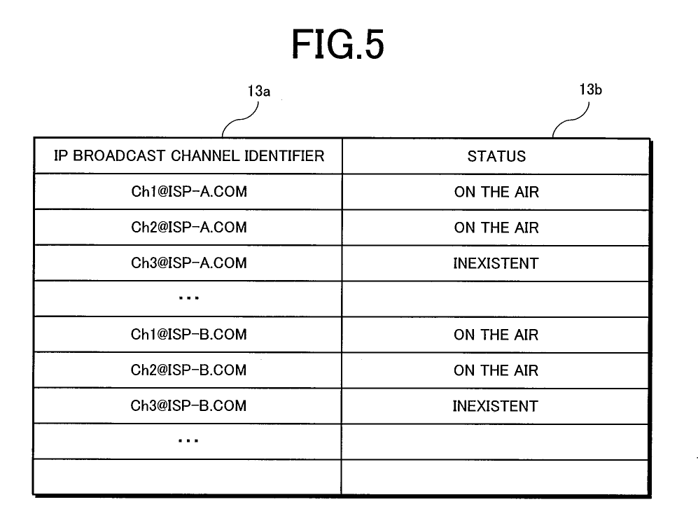

The IP broadcast channel management table 13, for example, as shown in FIG. 5, stores IP broadcast channel identifiers 13a and information indicating statuses corresponding to them. This embodiment shows that an IP broadcast channel identifier 13a is “Ch1@ISP-A.COM,” and a status corresponding to it is “On the air.” The IP broadcast channel management table 13 can also contain other information items.

Next, in Step 102, when the IP broadcast channel identifier exists, the CPU 15 consults the IP broadcast channel identifier-multicast address binding table 11 to search for a corresponding multicast address (Step 103).

In this embodiment, the IP broadcast channel identifier-multicast address binding table contains a list of IP broadcast channel identifier 11a and corresponding multicast addresses 11b as shown in FIG. 4. The IP broadcast channel identifier-multicast address binding table 11 is previously set in the multicast address management device 10 for IP broadcast. For example, an IP broadcast channel identifier 11a is “Ch1@ISP-A.COM,” and a multicast address 11b corresponding to it is “239.255.255.10.”

In Step 103, when a corresponding multicast address 11b exists, the CPU 15 generates a multicast address response message (FIG. 6(b)) including the multicast address 11b, and transmits it to the IP broadcast terminals (Step 104). As a result, the IP broadcast terminal 30 can selectively receive an IP packet, based on the received multicast address 11b.

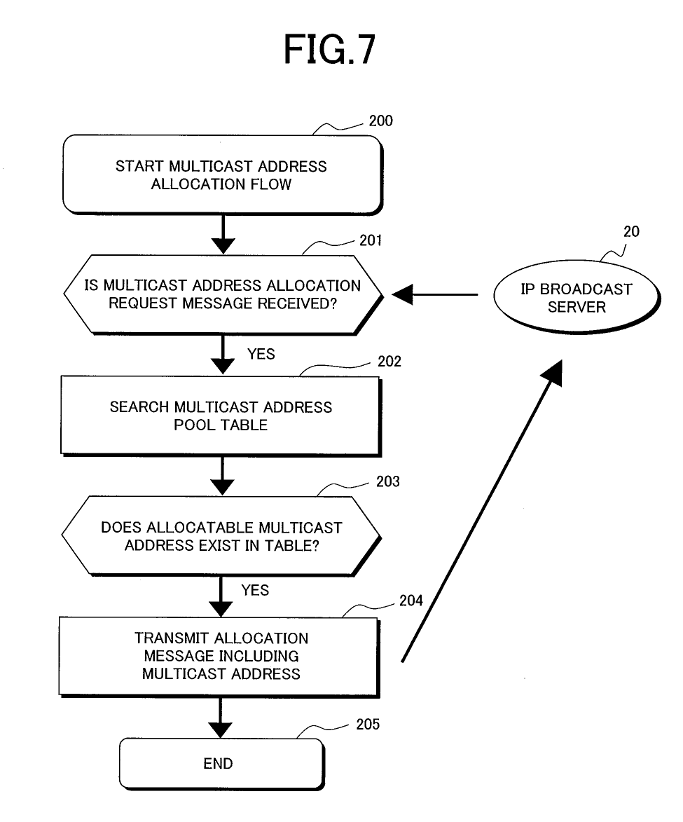

Next, FIG. 7 shows a flowchart of multicast address allocation operation executed by the multicast address management device 10 for IP broadcast. The multicast address management device 10 for IP broadcast responds to a multicast address allocation request from the IP broadcast servers 20 according to the flowchart, and allocates a multicast address. A flow of the above operation is described below.

First, the multicast address management device 10 for IP broadcast determines whether it has received a multicast address request message including an IP broadcast channel identifier from the IP broadcast servers 20 (Step 201). When receiving the multicast address request message, it extracts an IP broadcast channel identifier from the multicast address request message, and consults the multicast address pool table 12 to determine whether an allocatable multicast address exists (Steps 102 and 103).

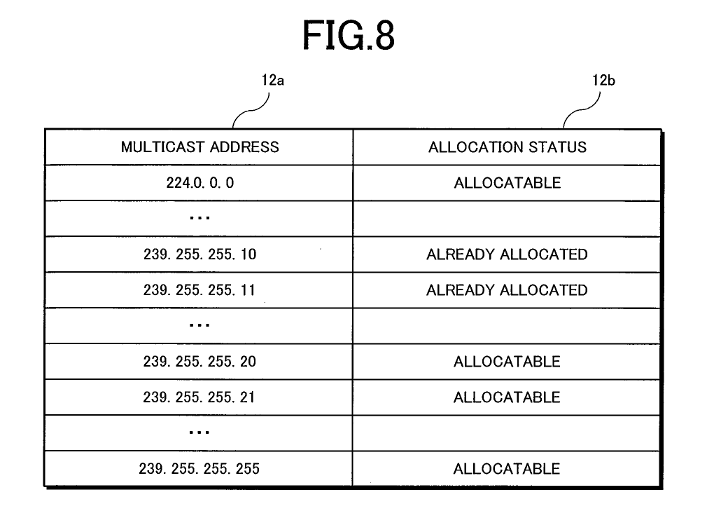

The multicast address pool table 12, for example, as its embodiment is shown in FIG. 8, stores multicast addresses 12a and information indicating allocation statuses 12b corresponding to them. This embodiment shows that a multicast address 12a is “224.0.0.0,” and an allocation status 12b corresponding to it is “Allocatable.” The multicast address pool table 12 can contain other information items, as detailed later.

Next, in Step 203, when an allocatable multicast address exists, the multicast address management device 10 for IP broadcast consults the multicast address pool table 12 to generate a multicast address allocation message including an allocatable multicast address, and transmits it the IP broadcast servers 20 (Step 204). It changes allocation status in the multicast address pool table 12 to “Already allocated.” Moreover, in the IP broadcast channel identifier-multicast address binding table 11, it updates the data of IP broadcast channel identifier information and multicast information.

As a result, the IP broadcast servers 20 transmit IP packets, based on the allocated multicast address 12a. Thereby, the multicast address management device 10 for IP broadcast can collectively manage multicast addresses, and can respond quickly to queries from the IP broadcast terminals.

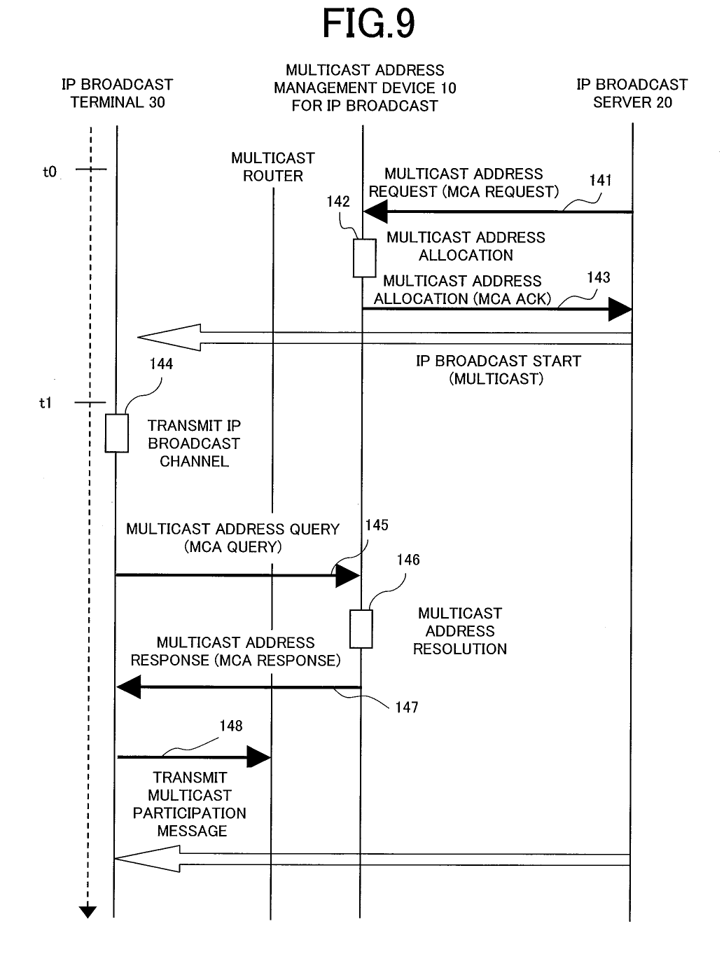

FIG. 9 is a drawing showing a message sequence for explaining the operation of the entire system in the above-described first embodiment. At time t0, a multicast address request (MCA Request) message transmitted from the IP broadcast server 20 is received by multicast address management device 10 for IP broadcast (Step 141). The multicast address management device 10 for IP broadcast, as shown in FIG. 7, consults the multicast address pool table 12 to decide a multicast address (Step 142), and transmits a multicast address allocation message to the IP broadcast server 20 (Step 143). As a result, the IP broadcast servers 20 transmit an IP packet including the allocated multicast address to start an IP broadcast. At this point, although the IP packet is transmitted to a multicast network, the IP broadcast terminal 30 does not receive it.

Next, to view the IP broadcast, at time t1, the user inputs or transmits a signal including an IP broadcast channel identifier to the IP broadcast terminals 30 by an IP broadcast channel selection request 70 (Step 144). The IP broadcast terminals 30, as shown in FIG. 2, transmit a multicast address query message including the IP broadcast channel identifier to the multicast address management device 10 for IP broadcast (Step 145).

Next, the multicast address management device 10 for IP broadcast, as shown in FIG. 3, refers to the received IP broadcast channel identifier and the IP broadcast channel identifier-multicast address binding table 11 to decide a corresponding multicast address (Step 146), and transmits a multicast address response message including the decided multicast address to the IP broadcast terminals 30 (Step 147).

The IP broadcast terminals 30 analyze the received multicast address response message to decide the multicast address to be received, transmit a multicast group participation message to a multicast router disposed in the multicast network 40, and after the IP broadcast terminals 30 have become ready for reception, selectively receive an IP packet (Step 148). As a result, the IP broadcast terminals 30 can receive broadcast video IP packets, and the user can view the IP broadcast.

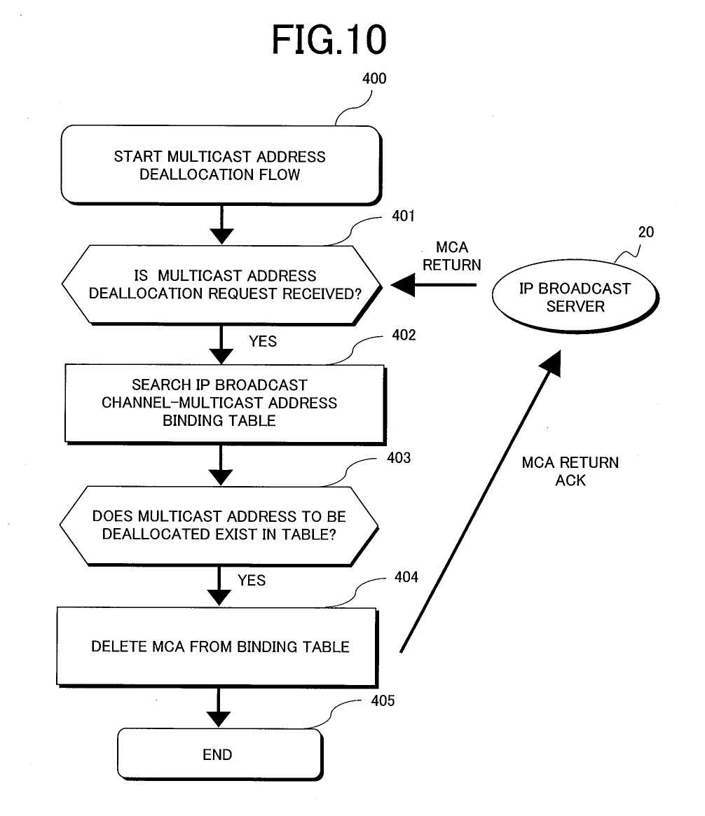

FIG. 10 shows a flowchart of multicast address deallocation operation executed by the multicast address management device 10 for IP broadcast in this embodiment. The multicast address management device 10 for IP broadcast deallocates a multicast address in response to a request to deallocate the multicast address from the IP broadcast servers 20. This operation flow is described using FIG. 10. This operation flow is executed by the CPU 15 of the multicast address management device 10 for IP broadcast.

First, the multicast address management device 10 for IP broadcast determines whether it has received a multicast address deallocation request message (MCA Return) including an IP broadcast channel identifier from the IP broadcast servers 20 via the network (Step 201). When receiving a multicast address deallocation request message, the CPU 15 extracts an IP broadcast channel identifier and a multicast address from the multicast address deallocation request message, and consults IP broadcast channel identifier-multicast address binding table 11 to determine whether the received IP broadcast channel identifier and multicast address exist (Steps 402 and 403).

Next, In Step 403, when the IP broadcast channel identifier and the multicast address exist, the CPU 15 deletes the received IP broadcast channel identifier and multicast address from the IP broadcast channel identifier-multicast address binding table 11, and generates a multicast address deallocation response message (MCA Return ACK) to transmit it to the IP broadcast servers 20 (Step 404). It changes allocation status in the multicast address pool table 12 to “Allocatable.” Moreover, it changes status in the IP broadcast channel management table 13 to “Inexistent.” As a result, the IP broadcast servers 20 return the right to use the multicast address to the multicast address management device 10 for IP broadcast. Thereby, the multicast address can be used again, so that the multicast network 40 can be efficiently operated.

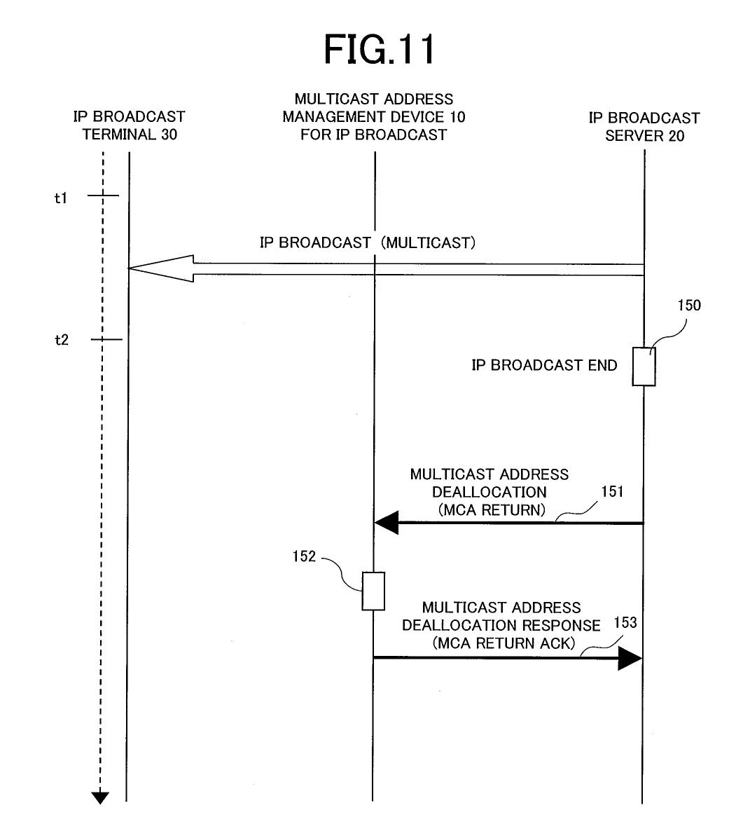

FIG. 11 is a drawing for explaining the sequence of deallocating the above-described multicast address. At time t2, the IP broadcast server 20 terminates IP broadcast (Step 150). Next, the IP broadcast servers 20 transmits a multicast address deallocation request message (MCA Return) to the multicast address management device 10 for IP broadcast (Step 151).

FIG. 11 is a drawing for explaining the sequence of deallocating the above-described multicast address. At time t2, the IP broadcast servers 20 terminate IP broadcast (Step 150). Next, the IP broadcast server 20 transmits a multicast address deallocation request message (MCA Return) to the multicast address management device 10 for IP broadcast (Step 151). The multicast address management device 10 for IP broadcast consults the multicast binding table 11 as shown in FIG. 10 to deallocate the multicast address (Step 152), and transmits a multicast address deallocation response message (MCA Return ACK) to the IP broadcast servers 30 (Step 153). As a result, the IP broadcast servers 20 return the right to use the multicast address, so that the multicast address management device 10 for IP broadcast can use the multicast address again.

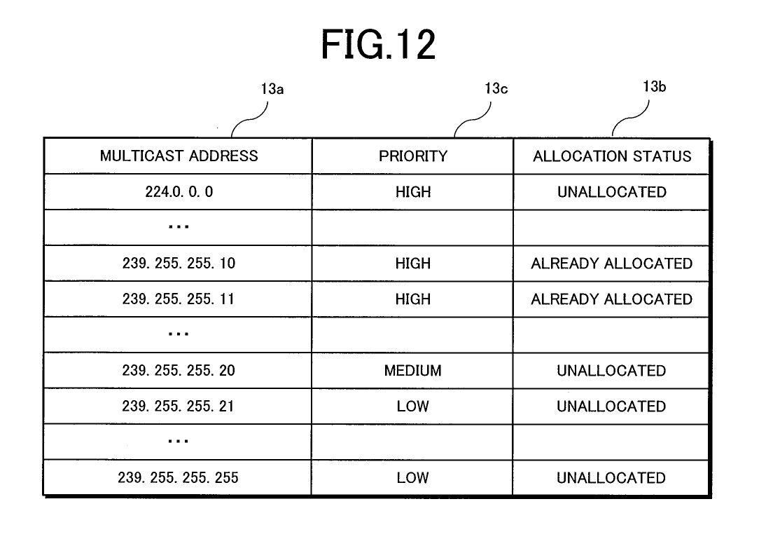

FIG. 12 shows another embodiment of the multicast address pool table 12 in the multicast address management device 10 for IP broadcast in this embodiment. The multicast address management device 10 for IP broadcast previously stores information for allocating a multicast address in the multicast network 40.

In this embodiment, as is apparent from FIG. 12, unlike the table of the embodiment shown in FIG. 8, the multicast address pool table 12 includes an information item of IP packet priority 13c in addition to multicast address 13a and allocation status 13b. This priority 13c shows the transferring priority of the packet corresponding to multicast address 13a. Thereby, when the multicast address management device 10 for IP broadcast has received a request of a multicast address of high priority from the IP broadcast server, it can allocate a multicast address 13a satisfying a condition. For example, packets allocated to a multicast address “239.255.255.10” are transferred with high priority. These transfer priorities are previously set by network infrastructure service providers such as carriers. Broadcasters, when distributing videos of high resolution, use multicast addresses of high transfer priority. A transfer priority of packets is decided based on the value of videos and contents.

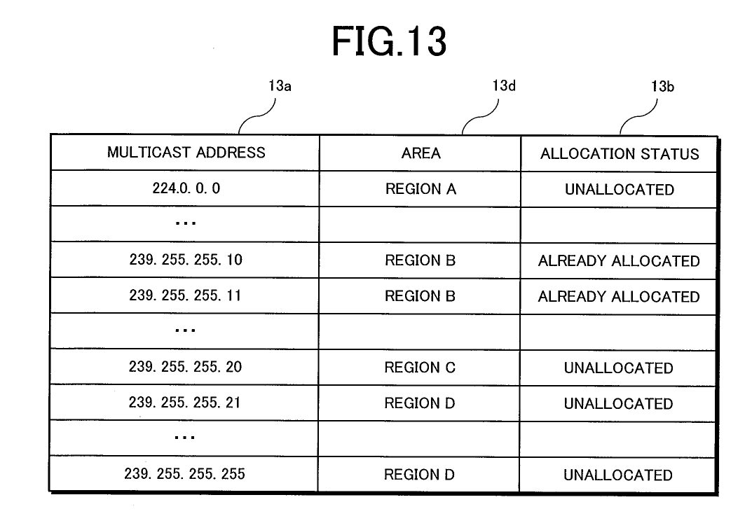

FIG. 13 shows another embodiment of the multicast address pool table in this embodiment. In this embodiment, the multicast address pool table includes, in addition to multicast address 13a and allocation status 13b, an information item of network area information 13d capable of transmitting IP packets with the multicast address 13a. Thereby, the multicast address management device 10 for IP broadcast, for example, when receiving a request for multicast address 13a to execute IP broadcast with an area limited, from the IP broadcast servers 20, can allocate a multicast address 13a satisfying the condition.

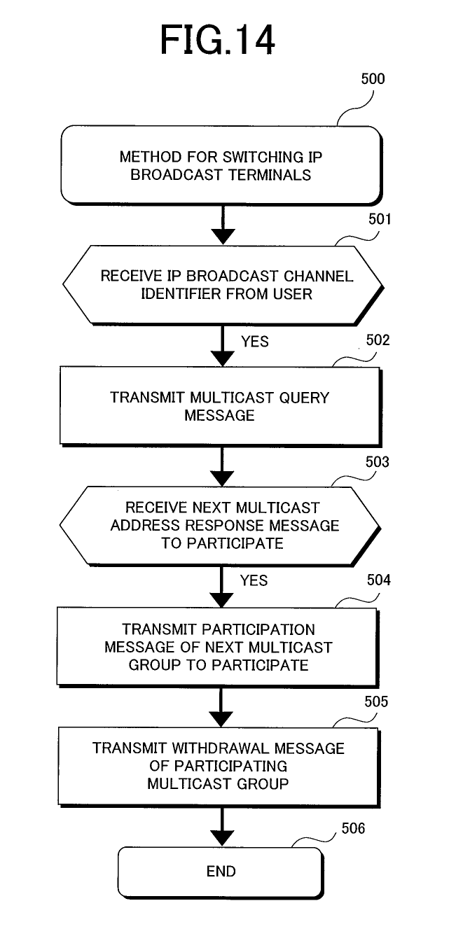

FIG. 14 shows a flowchart of channel switching operation executed by the IP broadcast terminals in this embodiment. Presently, the IP broadcast terminals 30 is receiving an IP broadcast indicating a multicast address “A.” First, the IP broadcast terminals 30 determine whether they have received an IP broadcast channel identifier including IP broadcast channel information the user newly views (Step 501). Next, when having received the IP broadcast channel identifier, they transmit a multicast address query message including the IP broadcast channel identifier (Step 502).

Next, the IP broadcast terminals 30 determine whether they have received a multicast address response message including the transmitted IP broadcast channel identifier and a corresponding multicast address “B” (Step 503). Next, when having received the multicast address response message, they transmit a message to participate in the multicast group “B” to the multicast network (Step 504). At the same time, they transmit a message to withdraw from the multicast group “A” to the multicast network (Step 505). Thereby, they can switch an IP broadcast channel from an IP broadcast channel indicating the multicast group “A” to an IP broadcast channel indicating the multicast group “B.” Although the order of Steps 504 and 505 is not fixed, precedent execution of Step 504 helps the user reduce channel switching time.

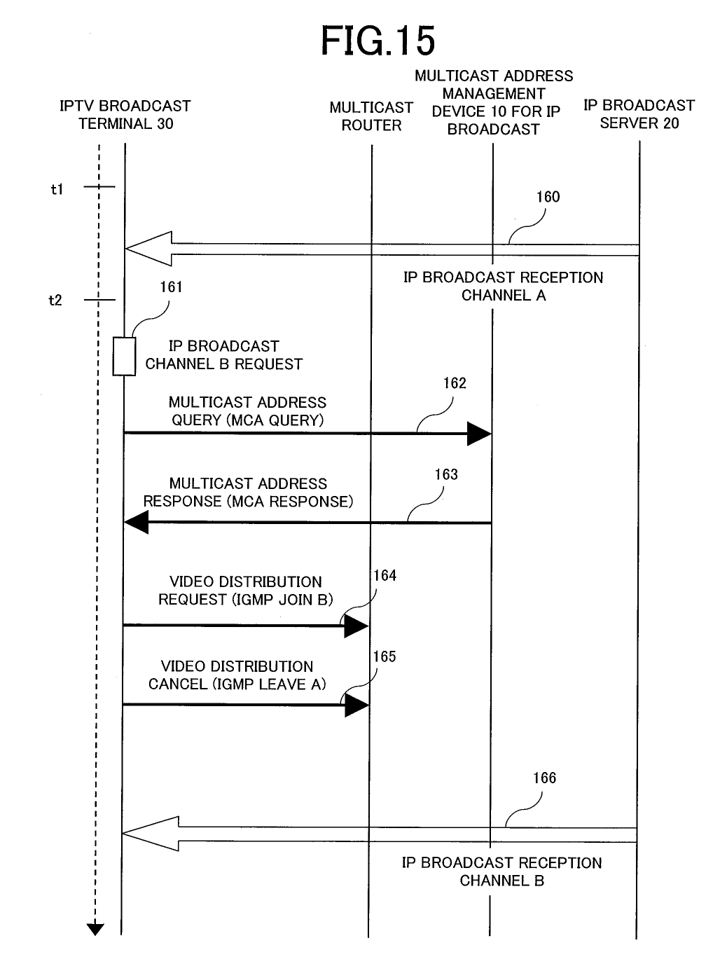

FIG. 15 shows a message sequence diagram of channel switching executed by the IP broadcast terminals in this embodiment.

At time t1, the IP broadcast terminals receive an IP broadcast channel A indicating a multicast address “A” (Step 160). At time t2, to view an IP broadcast channel B, the user inputs or transmits an IP broadcast channel B request signal including an IP broadcast channel identifier to the IP broadcast terminals 30 (Step 161). The IP broadcast terminals 30 transmits a multicast address query message including the IP broadcast channel identifier to the multicast address management device 10 for IP broadcast (Step 162). Next, the multicast address management device 10 for IP broadcast transmits a multicast address response message including the decided multicast address “B” to the IP broadcast terminals 30 (Step 163).

Next, the IP broadcast terminals 30 transmit a message to participate in the multicast group “B” or a video distribution request message to a multicast router (not shown) disposed in the multicast network (Step 164). At the same time or immediately after that (e.g., two or three seconds later), the IP broadcast terminals 30 transmit a message to participate in the multicast group “A” or a video distribution cancel message (Step 165). Thereby, the IP broadcast terminals 30 switch from a video of the IP broadcast channel indicating the multicast group “A” to a video of the IP broadcast channel indicating the multicast group “B.” As described above, the execution of the video distribution request (IGMP Join B) 164 precedent to the video distribution cancel (IGMP Leave A) 165 helps the user reduce channel switching time.

As is apparent from the above description, according this invention, in a multicast network capable of multicast routing, the load on users to set a multicast address can be reduced, and a method for receiving IP broadcast service and preferable receiving terminals can be provided which can reduce the load on IP broadcast terminals to set multicast.

1. An IP broadcast receiving method for receiving IP broadcast service in an IP broadcast terminal via an IP multicast network,
wherein an IP broadcast server that can distribute videos indicating a multicast address, and a multicast address management device for IP broadcast that holds the multicast addresses are connected to the IP multicast network, and
the IP broadcast terminal generates a query message including an IP broadcast channel identifier requested from a user, transmits the generated query message to the multicast address management device for IP broadcast, receives a response message including the multicast address corresponding to the IP broadcast channel identifier included in the query message from the multicast address management device for IP broadcast, and transmits a video reception request message to a multicast group decided for reception, using the multicast address included in the received response message.

2. The IP broadcast receiving method according to claim 1,
wherein the IP broadcast terminal includes a storage unit, and
the IP broadcast terminal extracts the multicast address from the response message, and stores information of correspondence between the IP broadcast channel identifier and the multicast address in the storage unit.

3. The IP broadcast receiving method according to claim 2,
wherein the IP broadcast terminal refers to the storage unit to decide the multicast address to be received, based on the IP broadcast channel identifier inputted from a user.

4. The IP broadcast receiving method according to claim 1,
wherein the IP broadcast receiving terminal, after transmitting a new video reception request message to another multicast group different from the multicast group being viewed, transmits a video reception cancel message to the multicast group being viewed.

5. The IP broadcast receiving method according to claim 1,
wherein the IP broadcast receiving terminal transmits a new query message including a newly inputted IP broadcast channel identifier to the multicast address management device for IP broadcast, receives a new multicast address corresponding to the new query message received from the multicast address management device for IP broadcast, and after transmitting a new video reception request message to another multicast group including the new multicast address, transmits a video reception cancel message to the multicast group being viewed.

6. An IP broadcast receiving terminal that receives videos distributed from a multicast group via an IP multicast network, comprising:
a processing unit that generates a query message including an IP broadcast channel identifier requested from a user;
a transmission unit that transmits the query message to a multicast address management device for IP broadcast that manages correspondence between IP broadcast channel identifiers and multicast addresses, connected to the IP multicast network; and
a receiving unit that receives a response message indicating the multicast address corresponding to the IP broadcast channel identifier from the multicast address management device for IP broadcast,
wherein the multicast address shown in the received response message is used to transmit a video reception request message from the transmission unit to a multicast group decided for reception.

7. The IP broadcast receiving terminal according to 6, further comprising a storage unit that can store correspondence information of the IP broadcast channel identifier and the multicast address,
wherein the processing unit extracts the multicast address from the response message, and stores the extracted multicast address and the corresponding IP broadcast channel identifier in the storage unit.

8. The IP broadcast receiving terminal according to 7,
wherein the storage unit comprises a cache memory.

9. The IP broadcast receiving terminal according to 7,
wherein the processing unit decides the multicast address corresponding to the inputted IP broadcast channel identifier, using the storage unit.

10. The IP broadcast receiving terminal according to 7,
wherein the processing unit, after transmitting a new video reception request message to another multicast group including the multicast address, performs control to transmit a video reception cancel message to the multicast group being viewed.

11. The IP broadcast receiving terminal according to 6,
wherein the processing unit, in response to a new query message including an IP broadcast identifier newly inputted from a user, after transmitting a new video reception request message to another multicast group including a new multicast address received from the multicast address management device for IP broadcast, performs control to transmit a video reception cancel message to the multicast group being viewed.
